(19) United States
(12) Patent Application Publication
(10) Pub. No.: US 2006/0136483 A1
(43) Pub. Date: Jun. 22, 2006

(54) System and method of decomposition of multiple items into the same table-column pair

(75) Inventors: Dung Kim Nguyen, San Jose, CA (US); Mayank Pradhan, San Jose, CA (US)

Correspondence Address: SANDRA M. PARKER, ESQ.;LAW OFFICE OF SANDRA M. PARKER, 329 La Jolla Avenue, LONG BEACH, CA, 90803, US

(73) Assignee: International Business Machines Corporation, Armonk, NY (US)

(21) Appl. No.: 11/021,771

(22) Filed: Dec. 22, 2004

(51) Int. Cl. G06F 17/30

(52) U.S. Cl. 707/102

(57) ABSTRACT

A system and computer-based method is provided for decomposing and storing content of a markup based document into a relational database. For a schema of a markup based document a user identifies multiple items mapping into a same database table-column pair and associates a rowset to each such item and a corresponding database table. Next, the user creates a mapping document based on the schema of the markup based document with rowset-specific mapping annotations defining mapping of the items into columns of the rowsets. Decomposition of each item into a corresponding rowset column is accomplished by collecting the item content from the markup based document and storing it in the corresponding rowset column, for later storage in a database table.

### BACKGROUND OF THE INVENTION

1. Field of the Invention

This invention relates in general to database management systems performed by computers, and in particular to an optimized method and system for decomposing markup based documents, such as XML documents, into a relational database wherein multiple items are decomposed into the same table-column pair.

2. Description of Related Art

Databases are computerized information storage and retrieval systems. A Relational Database Management System (RDBMS) is a database management system (DBMS) which uses relational techniques for storing and retrieving data. RDBMS software using a Structured Query Language (SQL) interface is well known in the art. The SQL interface has evolved into a standard language for RDBMS software and has been adopted as such by both the American National Standards Organization (ANSI) and the International Standards Organization (ISO).

Extensible Markup language (XML) is a standard data-formatting mechanism used for representing data on the Internet in a hierarchical data format and for information exchange. An XML document consists of nested element structures, starting with a root element.

Decomposition of an XML document is the process of breaking the document into component pieces and storing those pieces in a database. The specification of the pieces and where they are to be stored is accomplished by means of a mapping document. Mapping document may be in the form of a set of XML schema documents that describe the structure and data types used in conforming XML instance documents. XML schema documents are augmented with annotations that describe the mapping of XML components to tables/columns in a relational database. Annotations are a feature of XML schema that provide for application-specific information to be supplied to programs processing the schema or instance documents.

At least one conventional decomposition product using the XML schemas is limited because it can only map a single element/attribute item into a table-column pair. The problem is best described by exemplary FIGS. 1A-1B and FIGS. 2A-2B. FIGS. 1A-1B illustrate an XML document and FIGS. 2A-2B illustrate the associated XML Schema, created for this example.

The XML document of FIGS. 1A-1B contains branches of a company. Each branch has a name, phone number and address. Branches in the USA are allowed to have sub-branches under them. This is done by the use of element “sub-branches” as a child element of branches as the next sibling of the element “phone”. In addition, provision is made to accommodate companies that have branches in countries other than the USA, by putting such branches under the element “other-countries”. The branches in other countries are grouped by the country name, so that all branches of the same country appear together.

The XML Schema associated with XML document of FIGS. 1A-1B is shown in FIGS. 2A-2B. The aim is to create an address book of all the branches and sub-branches in the company. The expected relational database output, therefore, for the above XML document, would be as shown in FIG. 3. It is quite clear from the expected output that items from various parts of the XML document, with same and/or different element names, are being mapped into the same table-column pair. Thus, /branches/name and /branches/sub-branches/name are being mapped to org.branches.name, /branches/phone and /branches/sub-branches/phone are being mapped to org.branches.phone and /branches/address and /branches/sub-branches/address are being mapped to org.branches.address, although they belong to different branches types, namely, USA branches, USASubBranches or NonUSABranches.

For the XML document of FIGS. 1A-1B care has to be taken, when multiple items are mapped into the same table-column pair, to associate the correct branch with the correct address and phone number as there are multiple names, phone numbers and addresses in the document. However, it is not guaranteed that related name, address and phone number may appear sequentially, as is shown in the case of a branch having sub-branches where the sub-branch address appears before the parent branch's address. Therefore, in conventional systems there is a problem of identifying the items in the XML document that belong to the same row of the database table, as we do not want put the phone number of a branch and the address of its sub-branch in the same row. More generally stated, there is a problem in conventional methods for decomposition of XML documents, where multiple items are being mapped into the same table-column, in identifying the items in the XML document that belong to the same row.

While there have been various techniques developed for decomposing and storing of markup based documents, such as XML documents, in a database, there is a need for a simple, optimized method which will allow decomposition of multiple information items from an XML document into the same table-column pair.

### SUMMARY OF THE INVENTION

The foregoing and other objects, features, and advantages of the present invention will be apparent from the following detailed description of the preferred embodiments, which makes reference to several drawing figures.

One preferred embodiment of the present invention is a method for decomposing and storing the content of a markup based document into a relational database. For a schema of a markup based document a user identifies multiple items mapping into a same database table-column pair and associates a rowset to each such item and a corresponding database table. Next, the user creates a mapping document based on the schema of the markup based document with rowset-specific mapping annotations defining mapping of the items into columns of the rowsets. Decomposition of each item into a corresponding rowset column is accomplished by collecting the item content from the markup based document and storing it in the corresponding rowset column, for later storage in a database table.

Another preferred embodiment of the present invention is a system implementing the above-mentioned method embodiment of the present invention.

Yet another preferred embodiment of the present invention includes a computer usable medium tangibly embodying a program of instructions executable by the computer to perform method steps of the above-mentioned method embodiment of the present invention.

### BRIEF DESCRIPTION OF THE DRAWINGS

Referring now to the drawings in which like reference numbers represent corresponding parts throughout:

FIGS. 1A-1B illustrate an XML document;

FIGS. 2A-2B illustrate an exemplary XML Schema associated with the XML document of FIGS. 1A-1B;

FIG. 3 illustrates a relational database output for the XML document of FIGS. 1A-1B;

FIG. 4 illustrates the rowsets and the content of all the rows collected in each rowset, according to the preferred embodiments of the present invention;

FIG. 5 illustrates the structure of the “table” annotation, according to the preferred embodiments of the present invention;

FIGS. 6A-6D illustrate the annotation of the XML Schema of FIGS. 2A-2B with mapping information, according to the preferred embodiments of the present invention;

FIG. 7 illustrates a flowchart of the module used for the markup based document decomposition, according to the preferred embodiments of the present invention; and

FIG. 8 illustrates a computer hardware and software environment enabling decomposition, according to the preferred embodiments of the present invention.

### DETAILED DESCRIPTION OF THE PREFERRED EMBODIMENTS

In the following description of the preferred embodiments reference is made to the accompanying drawings, which form the part thereof, and in which are shown by way of illustration specific embodiments in which the invention may be practiced. It is to be understood that other embodiments may be utilized and structural and functional changes may be made without departing from the scope of the present invention.

The present invention discloses a system, method and computer usable medium, tangibly embodying a program of instructions executable by the computer to perform method steps of the present invention, for decomposing and storing of markup based documents, such as Extensible Markup Language (XML) documents, in a relational database, where multiple information items from the XML document are decomposed into the same table-column pair. The method and system of the present invention may be used in a distributed computing environment in which two or more computer systems are connected by a network, such as World Wide Web, including environments in which the networked computers are of different type.

The preferred method embodiment of the present invention decomposes the XML documents into database. Decomposition of an XML document is the process of breaking the document into component pieces and storing those pieces in a database. The specification of the pieces and where they are to be stored is accomplished by means of a mapping document. The mapping document is a set of XML schema documents that describe the structure of conforming XML instance documents. The XML schemas are augmented with annotations that describe the mapping of XML components to tables/columns in a relational database. Annotations provide application-specific information to programs processing the schema or instance documents. In the present invention items are decomposed into rowsets rather than tables. A rowset is a group of related information items that form a meaningful row. Each database table can have one or more rowsets associated with it.

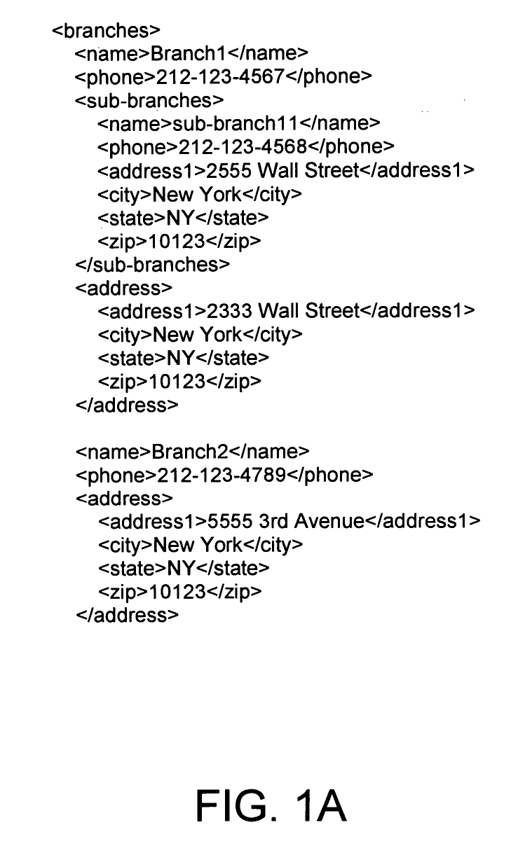

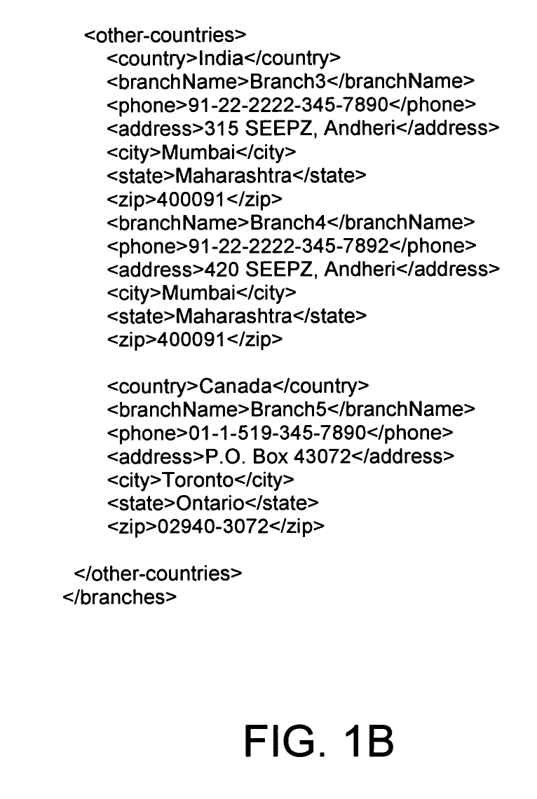

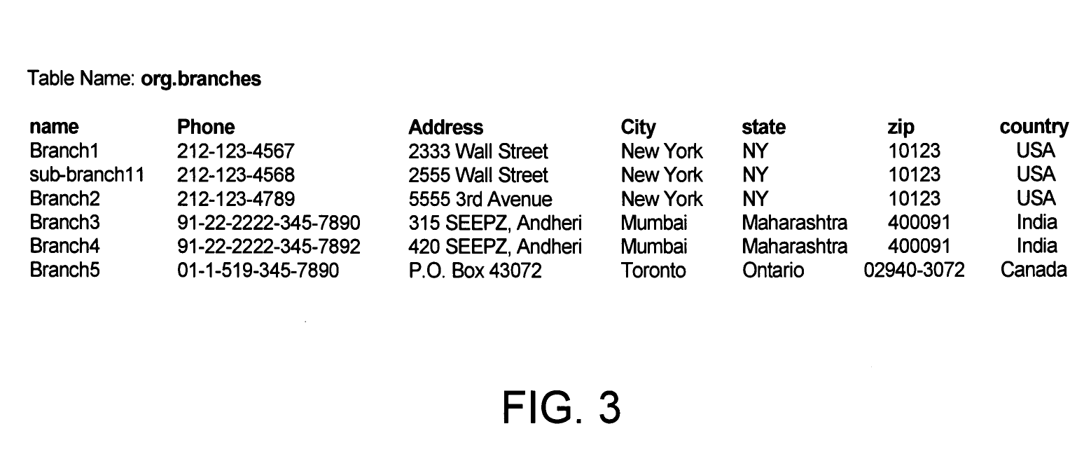

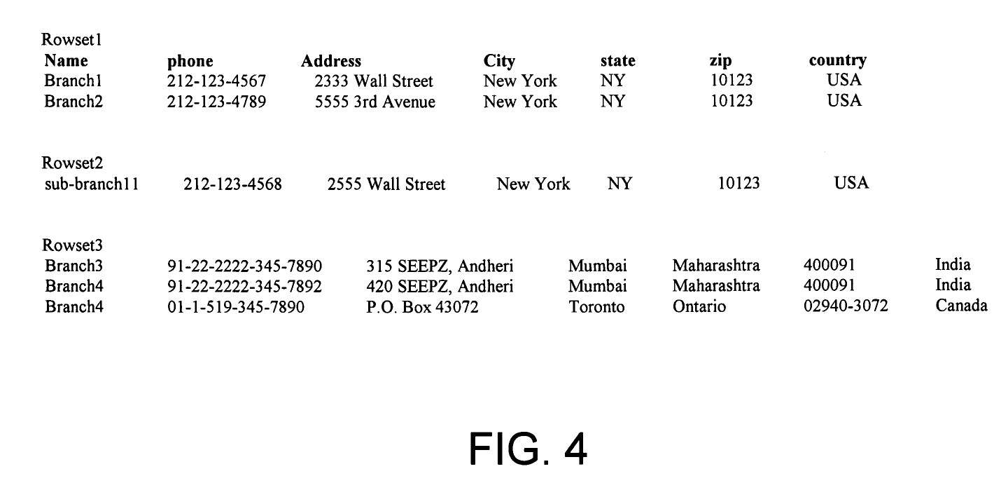

For the example of FIGS. 1A-1B, the preferred aspects of the present invention create three rowsets, as shown in FIG. 4. Rowset1 is a rowset for all branches in the USA. It contains the branch name, phone and address information for all branches in the USA that are not a sub-branch of some other branch. Rowset2 is a rowset for all the sub-branches associated with the parent branches, having the same information as Rowset1. Rowset3 is a rowset for branches outside of the USA. FIG. 4 illustrates the content of rows collected in each rowset. The final result of the decomposition is the union of all the rowsets associated with the XML document, so that all data are stored in the same physical table. Therefore, the final result of the operation Rowset1 U Rowset2 U Rowset3 is the output shown in FIG. 3 for the table “branches”.

Since the rowset information can be captured through annotations and the processing of a rowsets is intrinsic to the decomposition algorithm, the method and system of the present invention does not require creation and maintenance of any new database objects, therefore requiring no attention from the database administrators. Moreover, the application developer has full control over the names of the rowsets and can change them anytime, thus providing the flexibility and control.

The preferred aspects of the present invention use an XML Schema annotated with rowset-specific mapping information, provided in an annotation “table”. The annotation captures the name of the physical table in the database, the associated relational schema and one or more rowset names by which the table will be known in the annotated XML schema. The rowset names must be unique across the entire XML schema. For this reason, the annotation is considered as a global annotation, as a child annotation of the element “schema”.

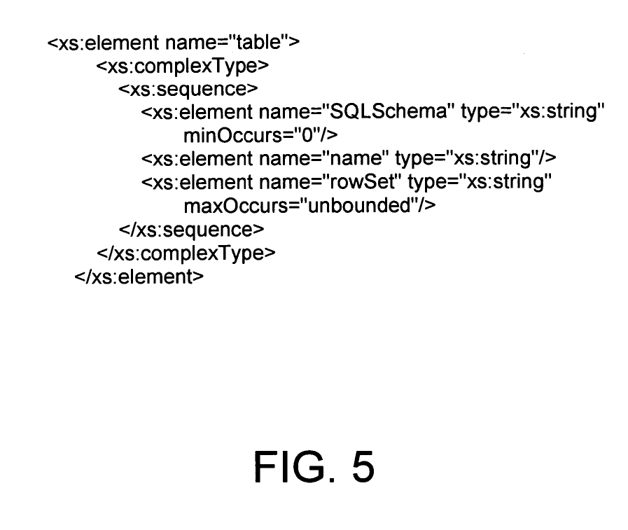

FIG. 5 illustrates the structure of the “table” annotation, created for the present invention and describing the annotations of the present invention. Sub-element “SQLSchema” contains the name of the relational schema of the table. Element “name” contains the name of the actual table that exists in the database. Element “rowSet” contains the names by which the table will be known in the given XML Schema. Therefore, the annotation “table” is used to define rowsets for the relational table.

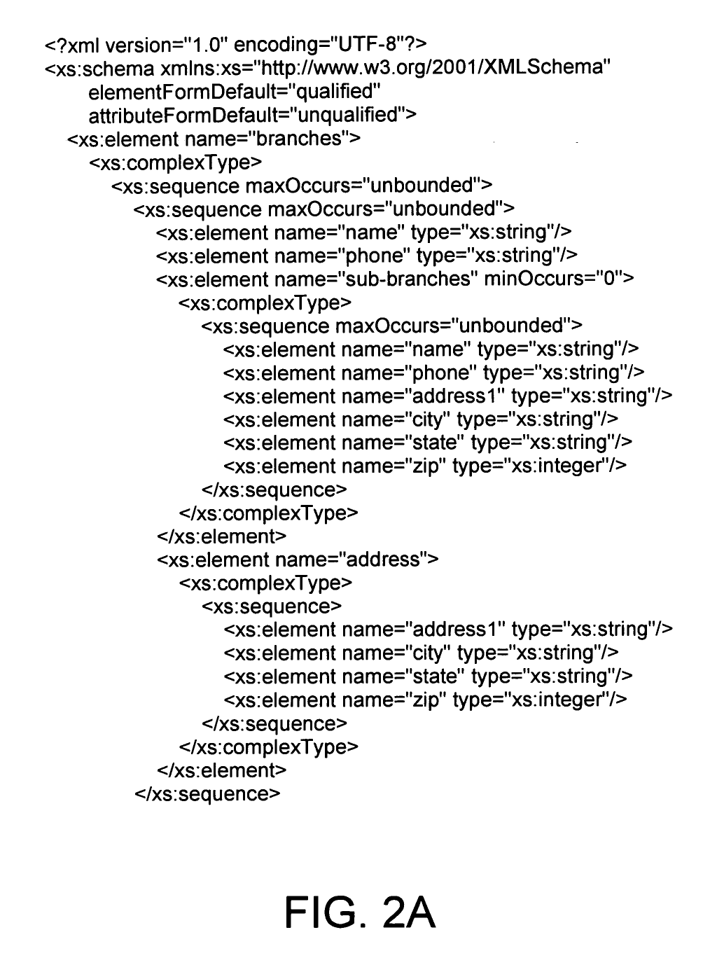

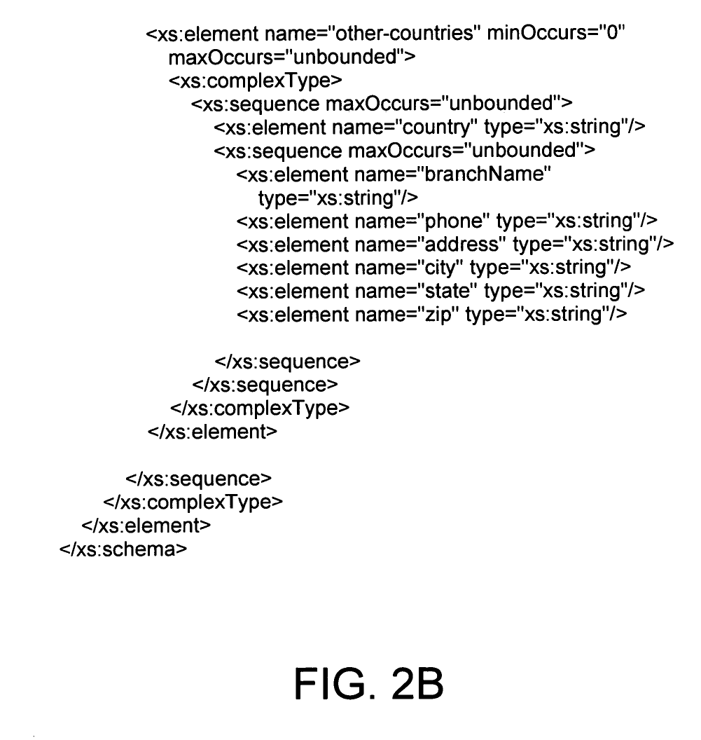

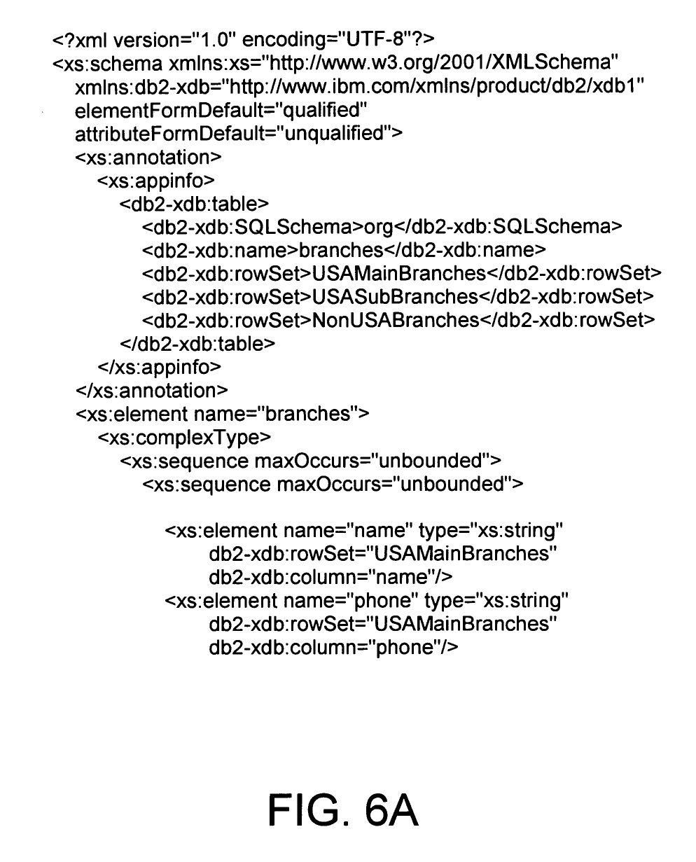

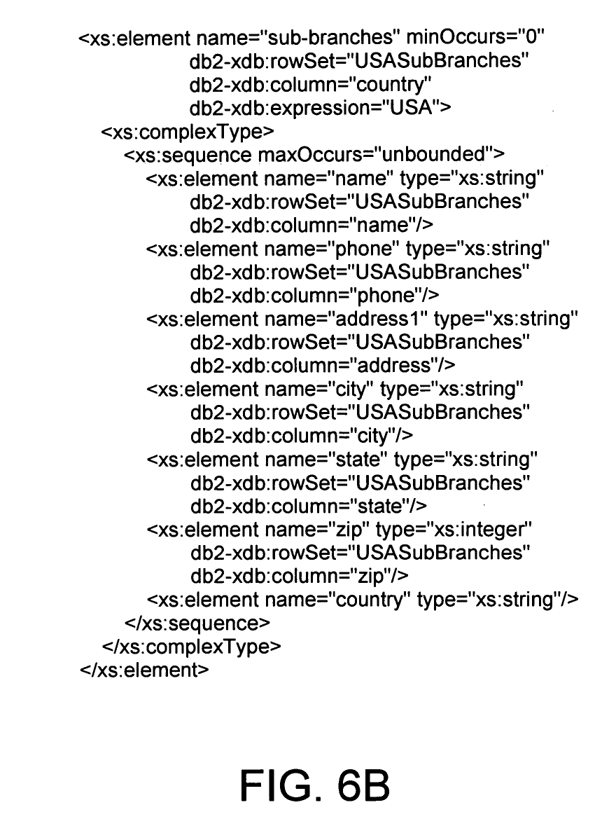

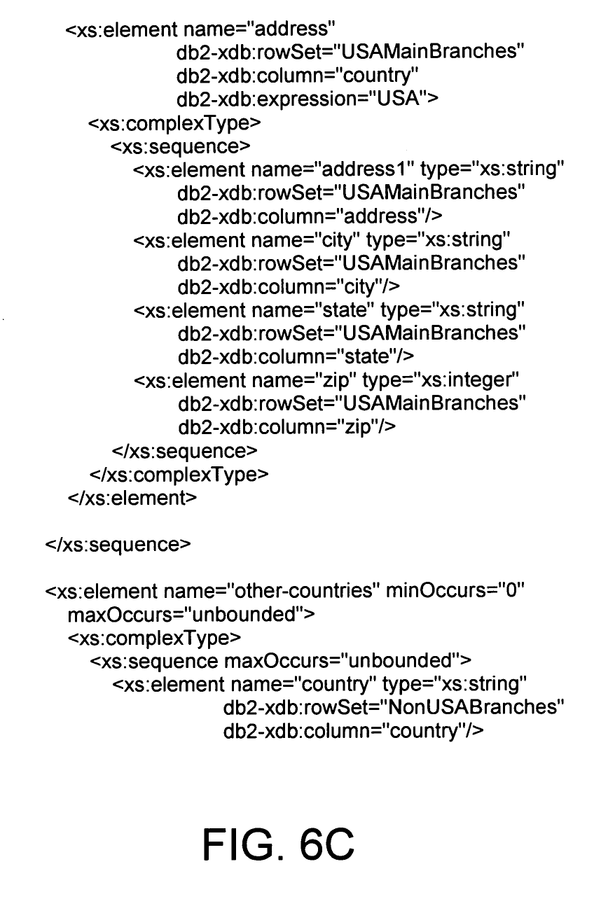

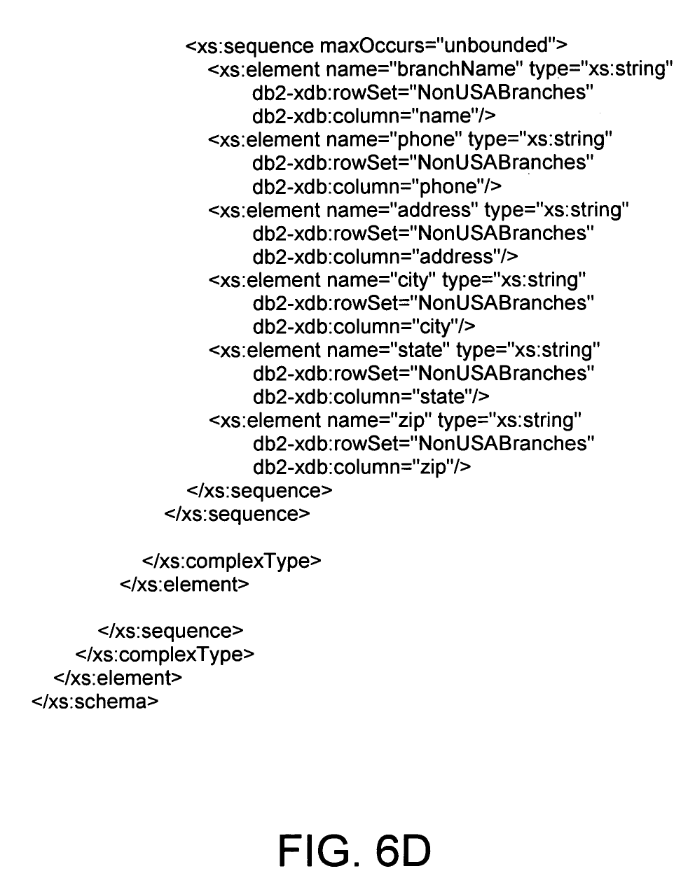

To achieve the results described above, a user must annotate the original XML Schema of FIGS. 2A-2B with mapping information, as shown in FIGS. 6A-6D. In FIGS. 6A-6D, the annotation db2-xdb:expression is used on the element declarations for sub-branches and the element address, defined under the element branches, and the annotation results in insertion of the literal “USA” into the specified rowset and column, as a default.

As it can be seen from the annotated XML Schema, the user must first define the rowsets for the table “branches” using the annotation “table”. Three rowsets, namely, USAMainBranches, USASubBranches and NonUSABranches, are defined in FIGS. 6A-6D, with the aim that the first rowset, USAMainBranches, will collect the content of all the rows for all the main branches in the document, the rowset USASubBranches will accumulate the content of all the rows for all the sub-branches that appear in the XML document and lastly, the rowset NonUSABranches will collect the content of all the rows corresponding to the branches outside the USA.

The annotated XML Schema of FIGS. 6A-6D, at relevant element declarations, has annotations used to define the mapping between the element and the corresponding rowset-column pair. This is achieved using the attribute annotations “db2-xdb:rowSet” and “db2-xdb:column”. Mapping annotations are indicated by the prefix “db2-xdb” which is associated with the namespace for DB2's decomposition feature: http://www.ibm.com/xmlns/product/db2/xdb1. For example, the following element declaration means that the element “name” is mapped to the rowset “USAMainBranches”:

<xs:element name=“name” type=“xs:string”

db2-xdb:rowSet=“USAMainBranches”
db2-xdb:column=“name”/>

The method of the present invention performs collection of element content and storage in the appropriate rowset according to the mapping information. In the example of FIGS. 6A-6D, for each occurrence of the element “name”, which is a child element of “branches” and, henceforth, identified by a location path /branches/name, the method of the present invention first collects and maps the content for the column called “name”, associated with rowset “USAMainBranches”. Similarly, information for other columns of the same row is also collected and mapped, so /branches/phone maps to USAMainBranches.phone, /branches/address/address1 maps to USAMainBranches.address, /branches/address/city maps to USAMainBranches.city, etc. The same logic is also used to accumulate the content of all the rows for the rowsets “USASubBranches” and “NonUSABranches”. At the end of the XML document decomposition, the method ensures that the physical database table has the rows collected for all rowsets. Thus, for the example of FIG. 4, the decomposition algorithm ensures that the result in the table “branches” is the union of rows collected in all three rowsets.

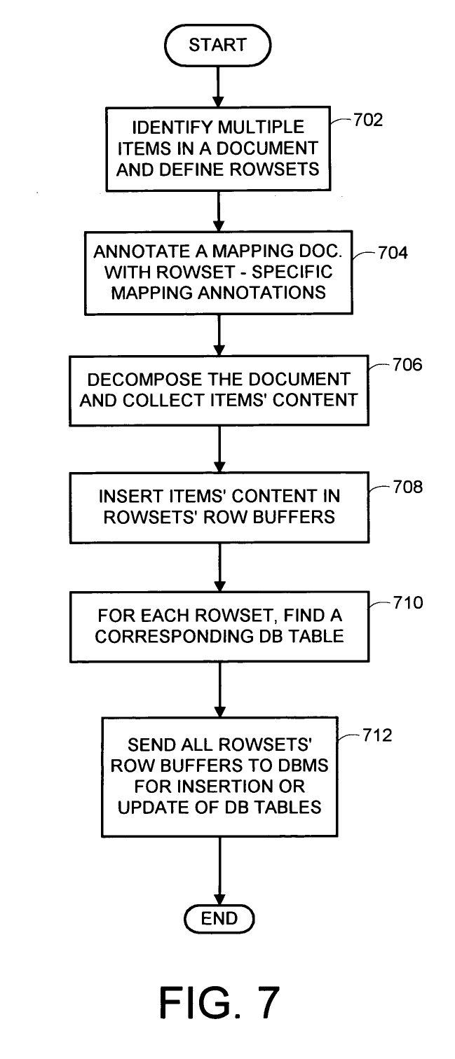

Flowchart of a computer-based method for decomposing and storing of a markup based document into a relational database, performed according to the preferred embodiments of the present invention, is illustrated in FIG. 7. In step 702 of FIG. 7, user identifies, for the markup based document, all multiple items mapping into a same database table-column pair and associates a rowset to each item and a database table. In step 704, user creates a mapping document, corresponding to the schema of the markup based document, which defines which table and column will hold the content of a markup based document item, with rowset-specific mapping annotations defining mapping of the items into the rowsets. Each rowset has a set of row buffers. Each row buffer holds content for all item columns belonging to a table row.

Step 706 performs decomposition of each markup based document item into a corresponding rowset column, by calling a decomposition utility and inputting to it the annotated mapping document and the instance markup based document. Decomposition utility parses the markup based document and collects each item's content. It finds the item mapping information in the element/attribute declaration in the mapping document, which includes a rowset and column names. Item content is inserted into the corresponding rowset row buffer column, for later storage in the corresponding database table row. Parsing of the markup based document continues until all items that have mappings are found and placed in corresponding rowset's row buffers' columns, in step 708. At the end of decomposition, a union of all the rowsets associated with each database table is created, and a database table corresponding to each rowset is found in step 710. In step 712 all rowsets' row buffers are sent to the DBMS for insertion into or update of the corresponding database tables.

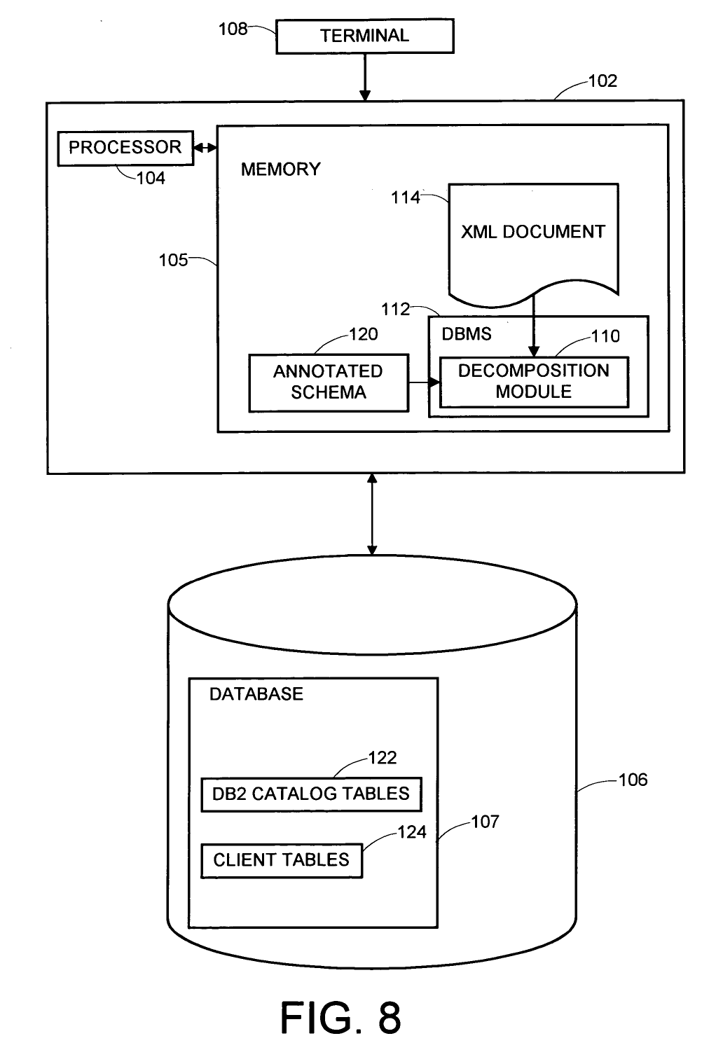

FIG. 8 illustrates an exemplary computer hardware and software environment usable by the preferred embodiments of the present invention for enabling decomposition. It includes a console 102 having one or more conventional processors 104 executing instructions stored in an associated computer memory 105, and having a console terminal 108. The memory 105 can be loaded with instructions received through an optional storage drive or through an interface with a computer network.

The processor 104 is connected to one or more electronic storage devices 106, such as disk drives, that store one or more relational databases 107. They may comprise, for example, optical disk drives, magnetic tapes and/or semiconductor memory. Each storage device permits receipt of a program storage device, such as a magnetic media diskette, magnetic tape, optical disk, semiconductor memory and other machine-readable storage device, and allows for method program steps recorded on the program storage device to be read and transferred into the computer memory. The recorded program instructions may include the code for the method embodiment of the present invention. Alternatively, the program steps can be received into the operating memory from a computer over the network.

Operators of the console terminal 108 use a standard operator terminal interface (not shown), to transmit electrical signals to and from the console 102, that represent commands for performing various tasks, such as search and retrieval functions, termed queries, against the databases 107 stored on the electronic storage device 106. In the present invention, these queries conform to the Structured Query Language (SQL) standard, and invoke functions performed by a DataBase Management System (DBMS) 112, such as a Relational DataBase Management System (RDBMS) software. In the preferred embodiments of the present invention, the RDBMS software is the DB2 product, offered by IBM for the AS400, OS390 or OS/2 operating systems, the Microsoft Windows operating systems, or any of the UNIX-based operating systems supported by the DB2. Those skilled in the art will recognize, however, that the present invention has application to any RDBMS software that uses SQL, and may similarly be applied to non-SQL queries.

FIG. 8 further illustrates a software environment enabling preferred embodiments of the present invention. In the system shown in FIG. 8 the console 102 further includes a decomposition software module 110 of the present invention. The computer-based decomposition software module 110 incorporates a method for transferring data contained in a markup based document, such as an XML document 114, into a relational database 107, stored in the electronic storage device 106. When the DBMS is DB2, relational database 107 has DB2 catalog tables 122 and client tables 124. Decomposition software module 110 is used for decomposing markup based documents, such as XML documents 114, into a relational database client tables 124, wherein multiple items are decomposed into the same table-column pair. For that purpose, decomposition software module 110 uses an annotated XML schema 120, created according to the preferred aspects of the present invention.

Although the description of the preferred embodiments of the present invention was based on XML documents, the present invention is applicable to other types of markup based documents. It is presently being implemented in the DB2 V9 product, which can support rowsets and annotated XML schemas. However, it is useable by end users of any DBMS products providing XML support, for processing and decomposition of XML documents. It will preferably be used for developing applications for DB2 machines. However, the technology may be applied to any other database manager products, such as Oracle, Informix, Sybase, SQL Anywhere, and Microsoft SQL Server, and other relational products.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-based method for decomposing and storing a markup based document into a relational database, comprising:
(a) identifying multiple items, for a schema of a markup based document, mapping into a same database table-column pair and associating a rowset to each said item and a corresponding database table;
(b) creating a mapping document based on the schema of the markup based document with rowset-specific mapping annotations defining mapping of the items into columns of the rowsets; and
(c) decomposing each said item content into a corresponding rowset column.

2. The method according to claim 1, wherein the rowset being a set of row buffers having columns belonging to the database table row, and the step of decomposing each said item into the corresponding rowset column comprises collecting the item content from the markup based document and storing the content in the corresponding row buffer column.

3. The method according to claim 1, wherein the rowset-specific mapping annotation comprises a name of each said rowset, the database table name and an associated relational schema, and wherein each said item mapping annotation defines mapping between the item and a corresponding rowset-column pair.

4. The method according to claim 1, further comprising a step of creating a union of the rowsets associated with each said database table, and sending all the rowsets to the DBMS for storage in the corresponding database table.

5. The method according to claim 1, wherein the markup based document being an Extensible Markup Language (XML) document and the mapping document being an annotated XML Schema.

6. The method according to claim 1, wherein the method being incorporated in a DB2 product.

7. A computer-based system for decomposing and storing a markup based document into a relational database, comprising means for:
(a) identifying multiple items, for a schema of a markup based document, mapping into a same database table-column pair and associating a rowset to each said item and a corresponding database table;
(b) creating a mapping document based on the schema of the markup based document with rowset-specific mapping annotations defining mapping of the items into columns of the rowsets; and
(c) decomposing each said item content into a corresponding rowset column.

8. The system according to claim 7, wherein the rowset being a set of row buffers having columns belonging to the database table row, and the means for decomposing each said item into the corresponding rowset column comprises means for collecting the item content from the markup based document and storing the content in the corresponding row buffer column.

9. The system according to claim 7, wherein the rowset-specific mapping annotation comprises a name of each said rowset, the database table name and an associated relational schema, and wherein each said item mapping annotation defines mapping between the item and a corresponding rowset-column pair.

10. The system according to claim 7, further comprising means for creating a union of the rowsets associated with each said database table, and sending all the rowsets to the DBMS for storage in the corresponding database table.

11. The system according to claim 7, wherein the markup based document being an Extensible Markup Language (XML) document and the mapping document being an annotated XML Schema.

12. The system according to claim 7, wherein the system being incorporated in a DB2 product.

13. A computer usable medium tangibly embodying a program of instructions executable by the computer to perform a computer-based method for decomposing and storing a markup based document into a relational database, comprising:
(a) identifying multiple items, for a schema of a markup based document, mapping into a same database table-column pair and associating a rowset to each said item and a corresponding database table;
(b) creating a mapping document based on the schema of the markup based document with rowset-specific mapping annotations defining mapping of the items into columns of the rowsets; and
(c) decomposing each said item content into a corresponding rowset column.

14. The method according to claim 13, wherein the rowset being a set of row buffers having columns belonging to the database table row, and the step of decomposing each said item into the corresponding rowset column comprises collecting the item content from the markup based document and storing the content in the corresponding row buffer column.

15. The method according to claim 13, wherein the rowset-specific mapping annotation comprises a name of each said rowset, the database table name and an associated relational schema, and wherein each said item mapping annotation defines mapping between the item and a corresponding rowset-column pair.

16. The method according to claim 13, further comprising a step of creating a union of the rowsets associated with each said database table, and sending all the rowsets to the DBMS for storage in the corresponding database table.

17. The method according to claim 13, wherein the markup based document being an Extensible Markup Language (XML) document and the mapping document being an annotated XML Schema.

18. The method according to claim 13, wherein the method being incorporated in a DB2 product.
